(19) United States
(12) Patent Application Publication
(10) Pub. No.: US 2015/0010161 A1
(43) Pub. Date: Jan. 8, 2015

(54) ADAPTER FOR REAL EAR MEASUREMENTS

(71) Applicant: OTICON A/S, Smorum (DK)

(72) Inventors: Svend Oscar PETERSEN, Smorum (DK); Bent SEVERIN, Smorum (DK); Oliver SUNDBERG, Smorum (DK); Søren WICHMANN, Smorum (DK)

(73) Assignee: OTICON A/S, Smorum (DK)

(21) Appl. No.: 14/293,647

(22) Filed: Jun. 2, 2014

(30) Foreign Application Priority Data
Jul. 2, 2013 (EP) 13174647.1

(51) Int. Cl. H04R 25/00

(52) U.S. Cl. CPC H04R 25/30
USPC 381/60

(57) ABSTRACT

An adapter configured to connect to a probe tube for calibrating a hearing aid device is disclosed. The adapter comprises a tubular pipe member and an opening through which the adapter is adapted to receive the probe tube. The adapter comprises an input member configured to connect to a connection member for providing fluid communication between the probe tube and the connection member through the adapter. An outer diameter of the probe tube is 5-20%, preferably 8-15% smaller than an inner diameter of the cylindrical space of the pipe member and that length of the cylindrical space of the pipe member is at least five times, preferably at least ten times larger than the outer diameter of the probe tube. Hereby it is achieved that a long narrow gab can be provided between probe tube and the pipe member of the adapter so that a sufficient acoustic seal can be accomplished.

### FIELD OF INVENTION

The present invention generally relates to an adapter for “real-ear measurements”. The present invention more particularly relates a calibration adapter for calibrating an in-situ “real-ear-measurement” system.

### DESCRIPTION OF RELATED ART

A variety of hearing aids have been developed to correct the hearing of users having different degrees of hearing impairments. In many situations an individual adjusting of the hearing aid is required in order to make the hearing aid work optimal.

Such adjustment is in particular important for children and people with a high degree of hearing impairment. However, these types of adjustments are also carried out in other types of users, depending on the individual sales or delivery office tradition. The adjustment is based on a so-called “real-ear measurement” (REM), where the sound pressure inside the ear canal in front of the eardrum is measured while the patient is wearing the hearing aid.

Usually the REM is carried out by the dispenser while the patient has a so-called “plug” in the ear canal. The plug is normally moulded to fit the outermost portion of the ear canal. The receiver is either provided in the plug, or placed in the hearing aid device. In the latter, the receiver is connected to the area in front of the eardrum by means of a tube extending through a through-going bore in the plug.

The measurement is carried out by arranging a small tube adjacent to the earplug and hereby providing an acoustic connection between the space between the plug and the eardrum and a microphone connected to the opposite end of the tube. When the receiver generates a given sound, it is possible to measure the sound pressure generated in front of the eardrum.

It is known to use an adapter for coupling an acoustic duct for REM to a microphone of a hearing aid device. It is known to use an adapter that comprises a sleeve configured to be arranged around the housing of a hearing aid device, wherein the sleeve has a sound opening allowing sound to pass from the acoustic duct to the microphone.

When performing REM and especially REM carried out by using a hearing instrument like when in-situ Real Ear to Coupler Difference (RECD) measurements are carried out, the measurement system is combined with different hardware parts. These different hardware parts have tolerances that one have to adjust for and that is why it is necessary to perform a calibration. When one have to calibrate a system that comprises a probe tube, it is difficult and challenging to connect the probe tube in a manner in which the connection is sufficiently acoustically sealed.

Thus, there is a need for an adapter that can be connected to a probe tube in an easy manner in which the connection is sufficiently acoustically sealed.

The present invention provides an adapter that can be connected to a probe tube in an easy manner in which the connection is sufficiently acoustically sealed.

Moreover, the invention also provides an adapter that can be used to calibrate a system comprising a hearing aid receiver and a probe microphone configured to be used in a REM setup, in which the receiver generates and transmits a sound into the user's ear, and where the sound pressure in front of the eardrum is measured with a probe microphone at the end of a probe tube.

### SUMMARY OF THE INVENTION

The present invention can be achieved by an adapter 2 as defined in claim 1. Preferred embodiments are defined in the dependent sub claims and explained in the following description and illustrated in the accompanying drawings.

The adapter according to the invention is an adapter configured to be connected to a probe tube for calibrating a hearing aid device, where the adapter comprises a tubular pipe member and an opening through which the adapter is adapted to receive the probe tube, where the adapter further comprises an input member configured to be connected to an connection member in order to provide fluid communication between the probe tube and the connection member through the adapter, where the probe tube has an outer diameter and where the tubular pipe member comprises a cylindrical space having an inner diameter and a length. The outer diameter of the probe tube is 5-20%, preferably 8-15% smaller than the inner diameter of the cylindrical space of the pipe member, and the length of the cylindrical space of the pipe member is at least five times, preferably at least ten times larger than the outer diameter of the probe tube.

Hereby it is achieved that a long narrow gab can be provided between probe tube and the pipe member of the adapter so that a sufficient acoustic seal is accomplished. In this way useful measurements may be carried out.

Moreover the adapter can be used to provide an easy way for the dispenser to connect and disconnect a probe tube to the outlet of a receiver.

Since the pipe member has a slightly larger inner diameter than the outer diameter of the probe tube, only a small friction force will occur between the probe tube and the pipe member. However, this limited friction force will be sufficient to ensure that the probe tube is kept in place and that the probe tube can be extracted by pulling the probe tube without difficulty.

The adapter is in particular suited for being used to calibrate a system comprising a hearing aid receiver and a probe microphone to be used in a REM setup in which the receiver plays a sound into a users ear, and where the sound pressure in front of the eardrum is measured by using a probe microphone arranged at the end of a probe tube, the distal end of which is placed in the ear canal.

The probe tube may be a thin flexible standard tube having a circular cross-sectional area.

The adapter may be used to calibrating different types of hearing aid device.

The tubular pipe member of the adapter may have any desired wall thickness and it is preferred that the opening has a geometry that provides easy access to the space within the pipe member. In this way it becomes easy to insert the probe tube into the pipe member.

The input member may have any desired shape, however, it is preferred that it fits to a standard connection member in such a way that it is configured to be connected to a standard connection member in order to provide fluid communication between the probe tube and the connection member through the adapter.

By securing that the outer diameter of the probe tube is 5-20%, preferably 8-15% smaller than the inner diameter of the cylindrical space of the pipe member and that the length of the cylindrical space of the pipe member is at least five times, preferably at least ten times larger than the outer diameter of the probe tube, it is ensured that a long narrow gab is provided between the probe tube and the inner surface of the pipe member. In this way it is possible to provide an acoustic seal that makes it possible to perform valid measurements by using the adapter.

According to an embodiment, a conical member is provided at the distal end of the pipe member and that the inner diameter of the outermost portion of the conical member is larger than the inner diameter of the cylindrical space of the pipe member.

Hereby the insertion of the probe tube into the pipe member is eased.

It may be beneficial that the adapter comprises an adapter member and a connection member, where the adapter member comprises a pipe member and a hollow top member arranged adjacent to the adapter member, where the connection member comprises a head configured to be attached to the top member of the adapter member and hereby providing fluid communication between the adapter member and the connection member, where the connection member is provided with a input member configured to be inputted into another connection member (e.g. of a hearing aid device).

Hereby it is achieved that the adapter can be connected to different connection members and that the configuration of the adapter can be changed in a fast and easy manner by attaching the head to the top member of the adapter member.

According to an embodiment, the connection member comprises a pipe member extending between the head and the input member and that a through-going canal is provided in the connection member.

Hereby it becomes easier to handle (get hold of it and to move it) the connection member and to attach it to the adapter member and to remove it therefrom.

It may be beneficial that a flexible and bendable link member is provided between the adapter member and the connection member. Hereby the attachment of the connection member to the adapter member and the removal of the connection member from the adapter member can be carried out in a fast and easy way. Moreover, the always connection member is always kept close to the adapter member.

According to an embodiment, the head is configured to be fastened to the top member of the adapter member by means of a press fit connection. Hereby a simple mechanical connection can be used to ensure a reliable and sufficient way of attaching the connection member to the adapter member of the adapter. Once the head has been pressed into the top member so that it has been received by the top member, the friction between the connection member and the adapter member ensures that the connection member is kept fastened to the adapter member. On the other hand it is preferred, that the head and the top member are shaped in such a way, that the connection member can be removed from the adapter member of the adapter by pulling the connection member.

According to an embodiment, the width of the pipe member is larger than the width of the input member. Hereby it is possible to provide a more robust and reliable connection member. In many cases a very thin input member may be required. Therefore, it is beneficial that the pipe member can be thicker and more robust.

It may be useful that the pipe member is symmetric about its longitudinal axis and/or that the top member is symmetrical about its longitudinal axis. Hereby it becomes easier to manufacture the pipe member and the top member since it becomes possible to e.g. mould two identical members and to join these.

According to an embodiment, the pipe member is symmetric about its longitudinal axis and that the top member is symmetrical about its longitudinal axis and that the longitudinal axis of the top member and the longitudinal axis of the pipe member are coincident.

Hereby it is ensured that the through-going canal of the adapter is straight and that the forces used during attachment of the connection member to the adapter member and during removal of the connection member from the adapter member are directed parallel to the longitudinal axis of both the top member and the pipe member. Accordingly, torsion of the top member and the pipe member can be reduced or even eliminated.

According to an embodiment, the adapter member comprises a stop member configured to prevent the probe tube from being inserted further into the adapter member. Hereby a fast, easy and precise arrangement of the probe tube within the adapter can be provided.

It may be beneficial that the stop member comprises a wall member extending basically perpendicular to the longitudinal axis of the adapter member. Hereby it is possible to provide a simple, reliable and secure way of providing the stop member.

According to an embodiment, the head comprises an annular protrusion configured to be received by a corresponding annular groove of the top member of the adapter member and/or that the head comprises a annular groove configured to receive an annular protrusion of the top member when the head is attached to the top member of the adapter member.

Hereby a simple and reliable mechanical fastening of the head within the top member can be provided.

According to an embodiment, the link member comprises a central portion with a reduced thickness. Hereby it becomes easier to bend the link member when the connection member has to be attached to the top member of the adapter member.

According to an embodiment, the link member has a first portion extending basically perpendicular to the outer surface of the adapter member and/or the longitudinal axis of the adapter member and that the link member has a second portion extending basically perpendicular to the outer surface of the connection member and/or the longitudinal axis of the connection member.

Hereby it becomes easier to attach the connection member to the top member of the adapter member and to remove the connection member from the top member of the adapter member.

It may be beneficial that the adapter is configured to be used to calibrate a system comprising a hearing aid receiver and a probe microphone configured to be used in a “real-ear measurement” (REM) setup, in which a receiver generates and transmits a sound into a user's ear, and where the sound pressure in front of the user's eardrum is measured with the probe microphone arranged at the end of the probe tube.

It may be useful to have a kit comprising an adapter according to the invention and a probe tube for performing a “real-ear measurement”.

It is preferred that the length of the pipe member of the adapter member is at least 10 mm or at least 10 times the diameter of the probe tube that the adapter is intended to be connected to.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 A) shows an adapter attached to a hearing aid device according to an embodiment of the invention;

FIG. 1 B) shows another way of attaching an adapter (similar to the one shown in FIG. 1 A)) to a hearing aid device according to an embodiment of the invention;

FIG. 1 C) shows the adapter attached to a thin tube solution according to an embodiment of the invention;

FIG. 1 D) shows the adapter attached to a RITE solution with a custom made shell according to an embodiment of the invention;

FIG. 2 A) shows a perspective view of a disassembled adapter according to an embodiment of the invention;

FIG. 2 B) shows a perspective cross-sectional view of the adapter shown in FIG. 2 A according to an embodiment of the invention;

FIG. 3 A) shows a perspective view of the adapter shown in FIG. 2 in an assembled state according to an embodiment of the invention;

FIG. 3 B) shows a perspective cross-sectional view of the adapter shown in FIG. 2 in an assembled state according to an embodiment of the invention;

FIG. 4 A) shows a cross-sectional view of an adapter in a disassembled state according to an embodiment of the invention;

FIG. 4 B) shows a cross-sectional view of the adapter in FIG. 4 A) in an assembled state according to an embodiment of the invention;

FIG. 4 C) shows a close-up cross-sectional view of the distal end of the probe tube shown in FIG. 4 B) according to an embodiment of the invention;

FIG. 5 A) shows a cross-sectional view of an adapter in a disassembled state according to an embodiment of the invention; and

FIG. 5 B) shows a cross-sectional view of the adapter shown in FIG. 5 A) in an assembled state according to an embodiment of the invention.

### DETAILED DESCRIPTION OF THE INVENTION

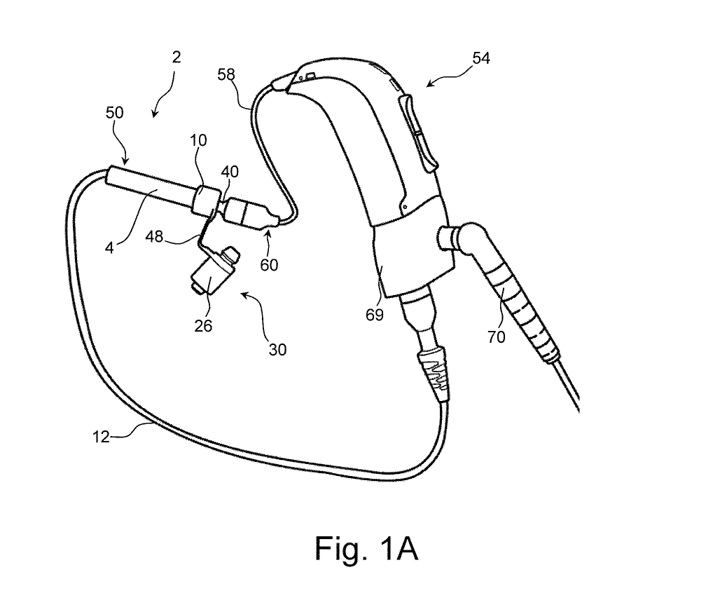

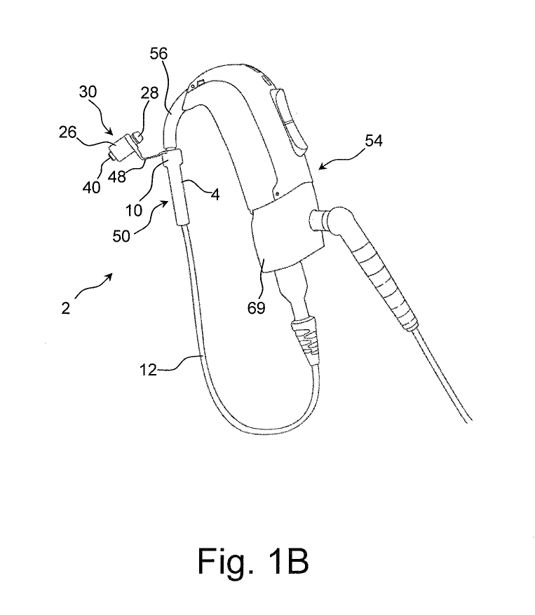

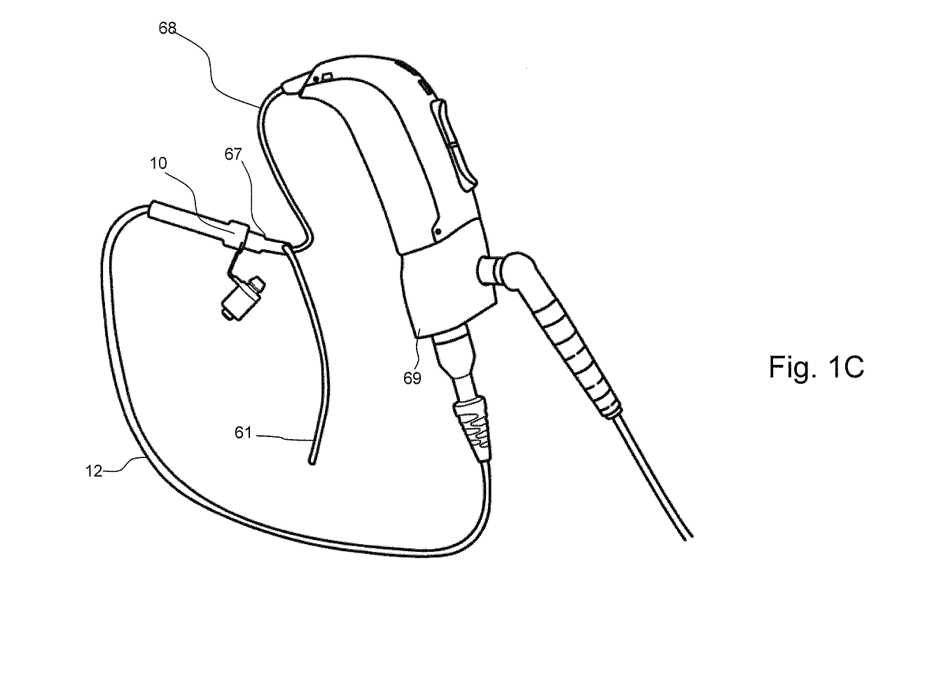

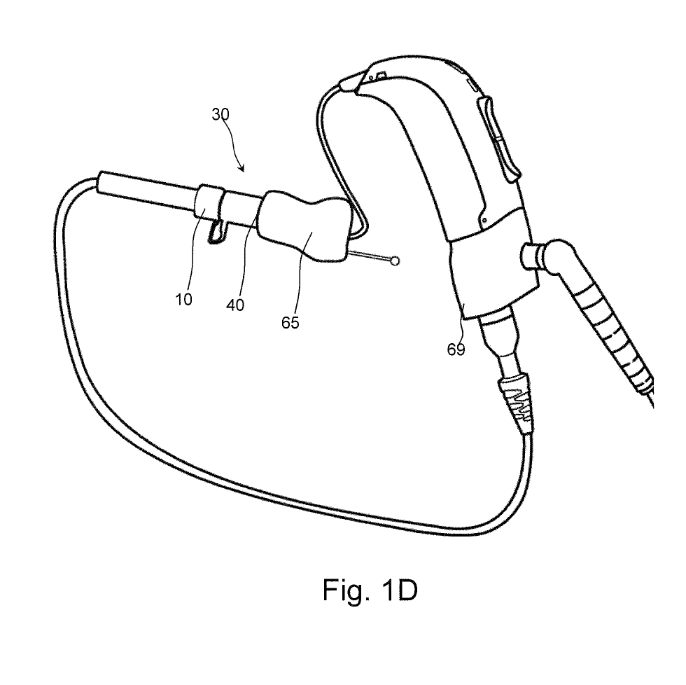

Referring now in detail to the drawings for the purpose of illustrating preferred embodiments of the present invention, different views of an adapter 2 according to the invention is illustrated in FIG. 1.

FIG. 1 A) illustrates a perspective view of an adapter 2 according to the invention. The adapter 2 comprises a connection member 30 and an adapter member 50 that are attached to each other. The connection member 30 comprises a cylindrical pipe member 26, while the adapter member 50 comprises a pipe member 4 that is attached to a top member 10 that is further connected to the connection member 30.

A link member 48 is provided between the pipe member 26 and the top member 10. The link member 48 is flexible and bendable and secures that the pipe member 26 is kept mechanically attached to the top member 10, when the connection member 30 is detached from the adapter member 50.

A thin flexible tube 12 has been inserted into the distal end of the adapter 2. The tube 12 has been inserted into the pipe member 4 of the adapter member 50.

A RITE receiver member 60 that is connected to a tube connection 58, having electric leads placed therein, is connected to the input member 40 of the connection member 30. The leads in tube connection 58 are connected to a hearing aid device 54. The thin flexible tube 12 is also connected to a microphone device. The microphone device 69 is hooked on to the hearing aid 54, and also connected to an external computing and measuring unit by leads 70 or wirelessly.

FIG. 1 B) illustrates a perspective view of the adapter 2 shown in FIG. 1 A). The connection member 30 of the adapter 2 has been detached from the adapter member 50 of the adapter 2. Accordingly, the connection member 30 is linked to the adapter member 50 via the link member 48.

The connection member 30 comprises an input member 40, a cylindrical pipe member 26 and a head 28 configured to be received and maintained by the top member 10.

A thin tube 12 has been inserted into the pipe member 4 of the adapter member 50. A sound tube 56 of a hearing aid device 54 is connected to the top member 10 of the adapter member 50.

FIG. 1 C shows the top member 10 connected to a thin sound tube 68, with a hollow handle 67 at the end thereof. The handle 67 also comprises a flexible strip member 61 which serves to hold the handle in place inside the ear canal (not shown) in the usual use of the thin tube 68 and handle part 67. In FIG. 1 C the sound tube 68 is coupled to the thin measuring tube 12 and through the tube 12 to the microphone device 69, for calibration purposes.

FIG. 1 D shows a connection where the connection member 30 is inserted in the top member 10 and a custom moulded shell 65 is connected to the open end 40 of the connection member 30.

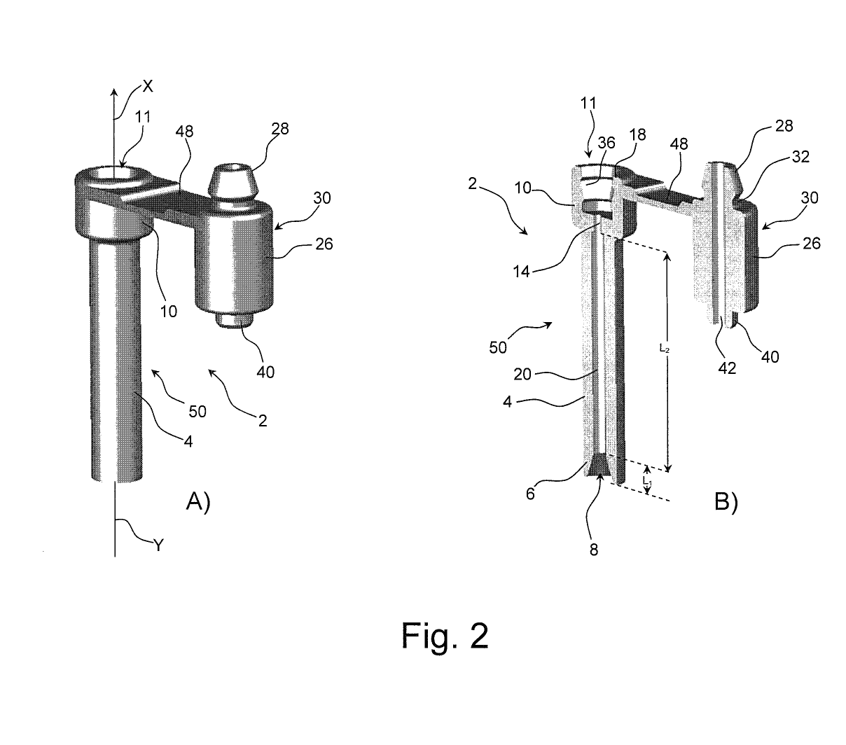

FIG. 2 A) illustrates a close-up perspective view of an adapter 2 according to the invention. The adapter 2 comprises an adapter member 50 having a tubular pipe member 4 and a tubular top member 10. The top member 10 is wider and shorter than the pipe member 4 and the top member 10 is arranged concentrically with respect to the pipe member 4. Accordingly, the longitudinal axis Y of the top member 10 and the longitudinal axis X of the pipe member 4 are coincident.

An opening 11 is provided in the top member 10, and the opening 11 is configured to receive a head 28 and to be mechanically attached to the head 28 of a connection member 30 that is linked to the top member 10 by means of a flexible and bendable link member 48 extending between and being attached to the top member 10 and a pipe member 26 of the connection member 30.

A tubular input member 40 is provided at the end of the pipe member 26 as an extension of the pipe member 26.

FIG. 2 B) illustrates a perspective cross-sectional view of the adapter 2 illustrated in FIG. 2 A).

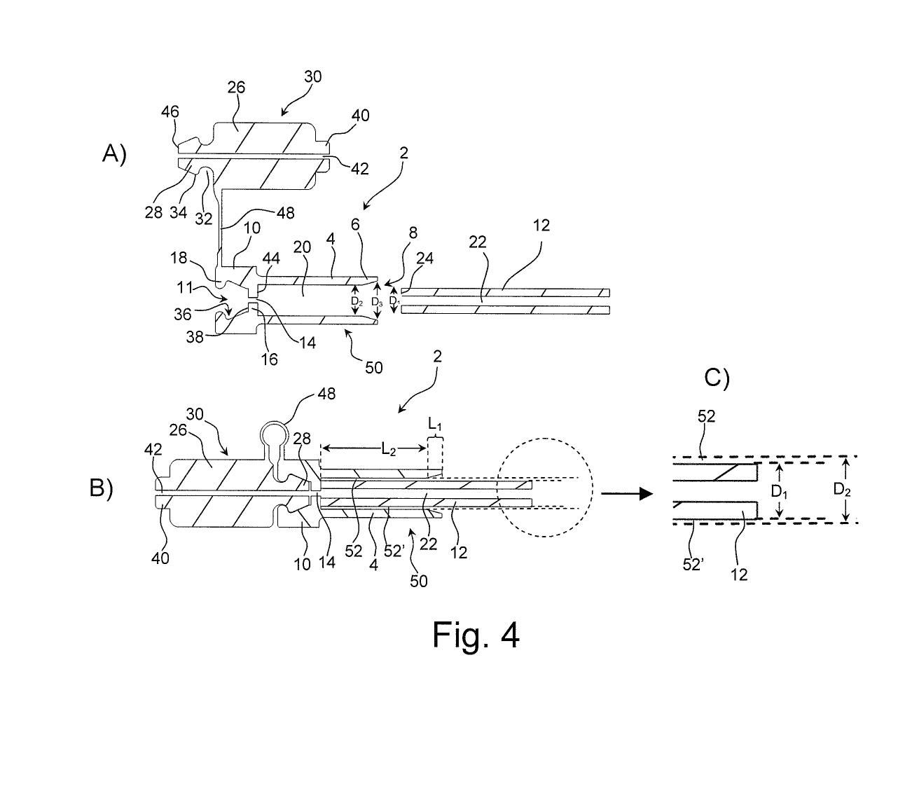

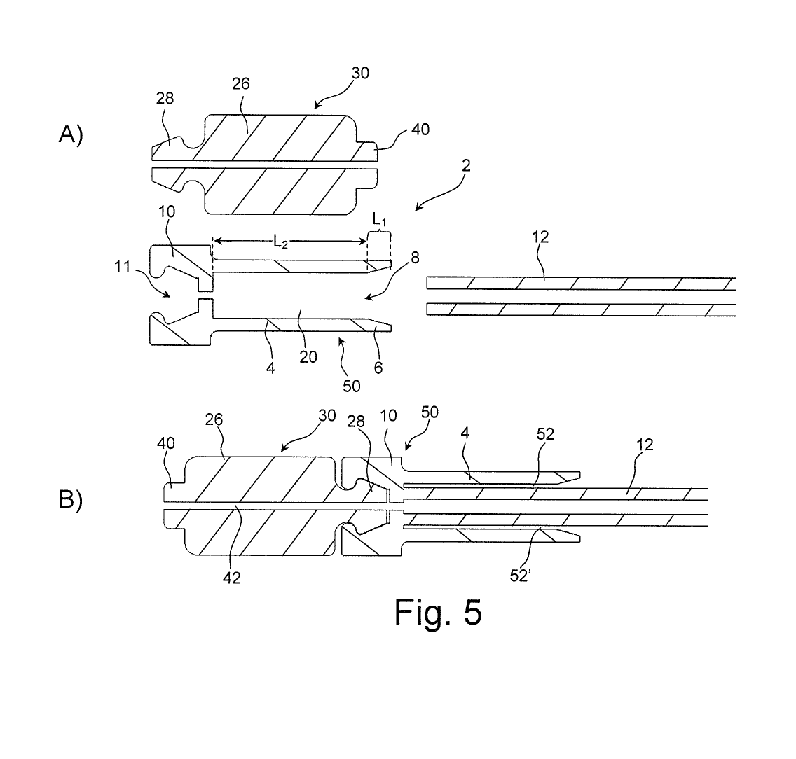

The adapter 2 comprises an adapter member 50 provided with a through-going canal. The adapter member 50 comprises a hollow cylindrical pipe member 4 provided with a space 20 a hollow conical member 6 provided at the end of the pipe member 4. The conical member 6 has an opening 8 configured to receive a probe tube (see FIG. 4 and FIG. 5). The adapter member 50 comprises a top member 10 having an annular groove 36 and an annular protrusion 18.

An aperture 14 is provided in the proximal end of the top member 10 and an opening 11 is provided at the distal end of the top member 10.

The adapter 2 comprises a hollow connection member 30 connected to the connection member 30 by a flexible and bendable link member 48. The connection member 30 comprises a cylindrical pipe member 26 sandwiched between a head 28 and a cylindrical input member 40. A through-going canal 42 is provided in the connection member 30. The through-going canal 42 extends through the head 28, the pipe member 26 and the input member 40. The input member 40 is configured to be inserted into a custom moulded shell 65 as illustrated in FIG. 1 D.

An annular groove 32 is provided at the neck of the head 28. The head 28 is configured to be received by the top member 10 of the adapter member 50. The annual groove 32 of the head 28 is adapted to receive the annular protrusion 18 of the top member 10, when the head 28 is attached to the top member 10.

A plate-shaped flexible and bendable link member 48 extends between the top member 10 and the connection member 30. Thus, the connection member 30 is always kept close to the adapter member 50. In this way it is possible to use the adapter 2 with or without the connection member 30 inserted into the top member 10.

The length L₂ of the pipe member 4 of the adapter member 50 is significantly larger than the length L₁ of the conical member 6 of the adapter member 50.

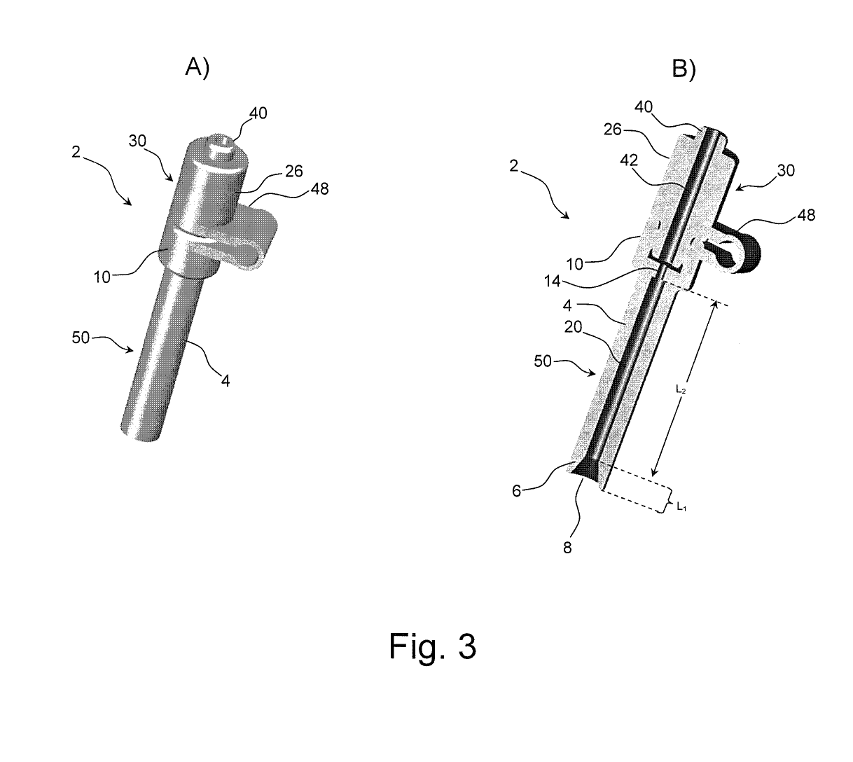

FIG. 3 A) illustrates a perspective view of the adapter 2 shown in FIG. 2. The connection member 30 of the adapter 2 is attached to the adapter member 50 of the adapter 2. The adapter member 50 comprises a pipe member 4 and a top member 10 extending as an extension of the pipe member 4. The top member 10 bears against the connection member 30 and is mechanically connected to the connection member 30 of the adapter 2.

The connection member 30 comprises a pipe member 26 having a width that corresponds to the width of the top member 10. An input member 40 is provided at the free end of the pipe member 26 of the connection member 30. The input member 40 is configured to be connected to a custom moulded shell 65, as seen in FIG. 1 D.

A flexible and bendable link member 48 mechanically links the top member 10 and the connection member to one another. The link member 48 comprises a central portion having a smaller thickness than the end portions of the link member 48. Hereby an increased flexibility of the central portion of the link member 48 can be achieved.

FIG. 3 B) illustrates a perspective cross-sectional view of the adapter 2 shown in FIG. 3 A). It can be seen that the connection member 30 of the adapter 2 is mechanically fixed to the adapter member 50 of the adapter 2. A space 20 is provided in the adapter member 50 and the adapter member 50 is provided with an aperture 14 constituting a through-going canal that is connected directly to the canal 42 of the connection member 30.

A conical member 6 is provided at the end of the pipe member 4 of the adapter member 50. A wide opening 8 is provided in the conical member 6. Accordingly, the conical member 6 has an optimal shape to receive a probe tube like illustrated in FIG. 4 and in FIG. 5. The length L₂ of the pipe member 4 is much larger than the length L₁ of the conical member 6 of the adapter member 50.

FIG. 4 A) illustrates a schematically cross-sectional view of an adapter 2 according to the invention. The adapter 2 comprises an adapter member 50 comprising a pipe member 4 arranged between a conical member 6 at the right side and a top member 10 at the left side. The top member 10 comprises a wall member 16 having a stop member 44 configured to prevent a tube 12 for being inserted the whole way through the adapter member 50. The wall member 16 of the top member 10 also comprises another stop member 38 providing a stop for the end 46 of the head 28 of the connection member 30, when the connection member 30 has been inserted into the opening 11 of the top member 10.

An aperture 14 is provided in the wall member 16 of the top member 10. The aperture 14 hereby provides fluid communication between the space 20 in the pipe member 4 and the opening 11 of the top member 10.

The top member 10 is equipped with an annular protrusion 18 and an annular groove 36. The annular groove 36 is configured to receive the annular protrusion 34 of the head 28 of the connection member 30. Similarly, the connection member 30 is provided with an annular groove 32 that is adapted to receive the annular protrusion 18 of the top member 10.

The connection member 30 comprises an input member 40 attached to its distal end. A through-going canal 42 is provided in the connection member 30.

A portion of a probe tube 12 is arranged adjacent to the opening 8 of the pipe member 4. It can be seen that the outer diameter D₁ of the probe tube 12 is smaller than the inner diameter D₂ of the pipe member 4. The outermost portion of the conical member 6 has a larger diameter D₃ than the inner diameter D₂ of the pipe member 4. The probe tube 12 has an inner space 22. The probe tube 12 is configured to be inserted into the pipe member 4 (see FIG. 4 B)) through the opening 8 in the conical member 6 of the adapter member 50. The end member 24 of the probe tube 12 is configured to bear against the stop member 44 of the top member 10, when the probe tube 12 has been fully inserted into the top member 10.

The connection member 30 and the adapter member 50 are mechanically attached to one another by a flexible and bendable link member 48 extending from the top member 10 of the adapter member 50 to the pipe member 26 of the connection member 30.

FIG. 4 B) illustrates a schematically cross-sectional view of the adapter 2 shown in FIG. 4 A) in a state, in which the probe tube 12 has been inserted into the pipe member 4 of the adapter 2.

It can be seen that a first gab 52 and a second gab 52′ is provided between the wall of the pipe member 4 and the outer surface of the probe tube 12. The limited size of the gabs 52, 52′ ensures that a sufficient acoustic seal can be accomplished.

The size of the gabs are so small that the viscou-thermal losses are sufficiently large to ensure that high quality measurements can be achieved (large viscous-thermal losses makes it possible to provide a good acoustic seal, whereas smaller viscous-thermal losses makes it difficult or impossible to provide a good acoustic seal).

In order to achieve the desired acoustic seal, the length of the pipe member 4 should be at least 5-10 mm or at least 5-10 times the diameter D₁ of the probe tube 12, however, it is preferred that the length of the pipe member 4 is at least 10 mm or at least 10 times the diameter D₁ of the probe tube 12.

It can be seen In FIG. 4 B) that the length L₂ of the pipe member 4 of the adapter member 50 is significantly larger than the length L₁ of the conical member 6 of the adapter member 50.

FIG. 4 c) illustrates a close-up view of the distal end of the probe tube 12 shown in FIG. 4 B). The outer diameter D₁ of the probe tube 12 is smaller than the inner diameter D₂ of the pipe member (see FIG. 4 A) and FIG. 4 B)). The width of the first gab 52 equals the width of the second gab 52′. Moreover, the width of each of the gabs 52, 52′ corresponds to approximately 5% of the inner diameter D₂ of the pipe member 4 of the adapter member 50.

Hereby the average distance between the outer side of the probe tube 12 and the inner side of the pipe member 4 is 5% of the inner diameter D₂ of the pipe member 4 and the maximum distance between the outer side of the probe tube 12 and the inner side of the pipe member 4 is 10% of the inner diameter D₂ of the pipe member 4. By limiting the width of the gabs 52, 52′ and at the same time applying a pipe member 4 that is sufficiently long, it is possible to provide long narrow gabs 52, 52′ that ensure that the viscou-thermal losses are sufficiently large not to influence the quality of the measurements carried out by using the adapter 2 connected to the probe tube 12.

It is important to underline that the probe tube 12 may be much longer than illustrated in FIG. 4.

FIG. 5 A) shows a schematically cross-sectional view of an adapter 2 according to the invention, in a disassembled state. The adapter 2 comprises two separate members: a connection member 30 and an adapter member 50.

The connection member 30 comprises a hollow cylindrical pipe member 26 arranged between a hollow cylindrical input member 40 and a head 28. The hollow cylindrical input member 40 has a smaller diameter than the cylindrical pipe member 26.

The adapter member 50 has a top member 10 with an opening 11, a hollow cylindrical pipe member 4 with a space 20, and a conical member 6 with an opening 8. The pipe member 4 is configured to receive a thin probe tube 12 arranged next to the pipe member 4, through the opening 8. The adapter 2 may be adapted to receive a thin probe tube 12 having an outer diameter of about 1.00 mm.

FIG. 5 A) shows that the length L₂ of the pipe member 4 is larger than the length L₁ of the conical member 6 of the adapter member 50.

FIG. 5 B) shows a schematically cross-sectional view of the adapter 2 shown in FIG. 5 A). The adapter 2 is illustrated in an assembled state and it can be seen, that the geometry of the head 28 of the connection member 30 fits the geometry of the top member 10 of the adapter member 50. The connection member 30 and the adapter member 50 are fastened to one another by means of a press fit connection.

The probe tube 12 has been fully inserted into the pipe member 4. Gabs 52, 52′ are provided between the outside of the probe tube 12 and the inside surface of the pipe member 4 of the adapter member 50.

The main difference between the adapter 2 shown in FIG. 4 and in FIG. 5 is the link member 48 connecting the connection member 30 and the adapter member 50 to each other. The embodiment illustrated in FIG. 5 does not have a link member 48 like the one shown in FIG. 5.

The adapters 2 shown in the FIG. 1-5 are adapted to receive a thin and very flexible tube 12 and to keep the tube 12 maintained within the (pipe member 4 of the) adapter 2 with a certain but limited retention force. This allows the user to insert the (probe) tube 12 into the (pipe member 4 of the) adapter 2 and to extract the (probe) tube 12 from the adapter 2 again without use of a significant force or much dexterity.

The cylindrical hollow pipe member 4 of the adapter member 50 works as a funnel making it easy for the user to put the tube 12 into the pipe member 4.

The cylindrical pipe member 4 has a slightly larger inner diameter D₂ than the outer diameter D₁ of the tube 12. Never the less a small friction force will be provided between the tube 12 and the pipe member 4. This friction force will be sufficient to keep the tube 12 in place. The tube 12 can be extracted by pulling slightly thereon.

The adapter 2 is configured to be used to calibrate a system comprising a hearing aid receiver and a probe microphone to be used in a REM setup, in which the receiver generates a sound and transmits the sound into the users ear, and the sound pressure in front of the eardrum is measured with a probe microphone arranged at the end of a probe tube 12, the distal end of which is placed in the ear canal.

In this measuring setup, the receiver in the hearing aid device 54 has a characteristic which is not sufficiently well known. In order to overcome this problem, the probe tube 12 is initially connected directly to the receiver and a calibration measurement is performed. The next step is to remove the adapter 2, connect the receiver to the ear plug and put the probe tube 12 into the ear along with the plug. Hereafter the REM can be performed.

The adapter 2 according to the invention provides an easy way (for the dispenser) to connect and disconnect the probe tube 12 to the outlet from the receiver. Moreover, the construction of the pipe member 4 makes it possible to provide long narrow gabs 52, 52′ between probe tube 12 and the pipe member 4 of the adapter 2 ensures that a sufficient acoustic seal is accomplished.

It should be appreciated that reference throughout this specification to “one embodiment” or “an embodiment” or features included as “may” or “can” means that a particular feature, structure or characteristic described in connection with the embodiment is included in at least one embodiment of the invention. Therefore, it is emphasized and should be appreciated that two or more references to “an embodiment” or “one embodiment” or “an alternative embodiment” or features included as “may”/“can” in various portions of this specification are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention.

Accordingly, the scope of the invention should be judged in terms of the claims which follow.

### LIST OF REFERENCE NUMERALS

2—Adapter
4—Pipe member
6—Conical member
8, 11—Opening
10—Top member
12—Tube
14—Aperture
16—Wall member
18—Annular protrusion
20, 22—Space
24—End member
26—Pipe member
28—Head
30—Connection member
32—Annular groove
34—Annular protrusion
36—Annular groove
38—Stop member
40—Input member
42—Canal
44—Stop member
46—End
48—Link member
50—Adapter member
52, 52′ —Gab
54—Hearing aid device
56—Connector
58—Tube connection
60—Connection member
61—Strip member
65—Custom shell
67—Handle
68—Thin sound tube
96—Microphone device
70—Wire connection
X, Y—Longitudinal axis
L₁, L₂—Length
D₁, D₂, D₃—Diameter

1. An adapter configured to be connected to a probe tube for calibrating a hearing aid device, where the adapter comprises a tubular pipe member and an opening through which the adapter is adapted to receive the probe tube, where the adapter further comprises an input member configured to be connected to an connection member in order to provide fluid communication between the probe tube and the connection member through the adapter, where the probe tube has an outer diameter (D₁) and where the tubular pipe member comprises a cylindrical space having an inner diameter (D₂) and a length (L₂) wherein the outer diameter (D₁) of the probe tube is 5-20%, preferably 8-15% smaller than the inner diameter (D₂) of the cylindrical space of the pipe member and that the length (L₂) of the cylindrical space of the pipe member is at least five times, preferably at least ten times larger than the outer diameter (D₁) of the probe tube.

2. The adapter according to claim 1, wherein a conical member is provided at the distal end of the pipe member and that the inner diameter (D₃) of the outermost portion of the conical member is larger than the inner diameter (D₂) of the cylindrical space of the pipe member (4).

3. The adapter according to claim 1, wherein the adapter comprises an adapter member and a connection member, where the adapter member comprises the pipe member and a hollow top member arranged adjacent to the adapter member, where the connection member comprises a head configured to be attached to the top member of the adapter member and hereby providing fluid communication between the adapter member and the connection member, where the connection member is provided with an input member.

4. The adapter according to claim 3, wherein the connection member comprises a pipe member extending between the head and the input member and that a through-going canal is provided in the connection member.

5. The adapter according to claim 3, wherein a flexible and bendable link member is provided between the adapter member and the connection member.

6. The adapter according to claim 3, wherein the head is configured to be fastened to the top member of the adapter member by means of a press fit connection.

7. The adapter according to claim 1, wherein a width of the pipe member is larger than a width of the input member.

8. The adapter according to claim 1, wherein the pipe member is symmetric about its longitudinal axis (Y) and/or that the top member is symmetrical about its longitudinal axis (X).

9. The adapter according to claim 8, wherein the pipe member is symmetric about its longitudinal axis (Y) and that the top member is symmetrical about its longitudinal axis (X) and that the longitudinal axis (Y) of the top member and the longitudinal axis (X) of the pipe member are coincident.

10. The adapter according to claim 3, wherein the adapter member comprises a stop member configured to prevent the probe tube from being inserted further into the adapter member.

11. The adapter according to claim 10, wherein the stop member comprises a wall member extending basically perpendicular to the longitudinal axis (X) of the adapter member.

12. The adapter according to claim 3, wherein the head comprises an annular protrusion configured to be received by a corresponding annular groove of the top member of the adapter member and/or that the head comprises a annular groove configured to receive an annular protrusion of the top member, when the head is attached to the top member of the adapter member.

13. The adapter according to claim 5, wherein the link member comprises a central portion in which the thickness of the link member is reduced.

14. The adapter according to claim 1, wherein the adapter is configured to be used to calibrate a system comprising a hearing aid receiver and a probe microphone configured to be used in a “real-ear measurement” setup, in which a receiver generates and transmits a sound into a user's ear, and where the sound pressure in front of the user's eardrum is measured with the probe microphone arranged at the end of the probe tube.

15. A kit comprising an adapter according to claim 1 and a probe tube for performing a “real-ear measurement”.

16. A kit comprising an adapter according to claim 2 and a probe tube for performing a “real-ear measurement”.

17. A kit comprising an adapter according to claim 3 and a probe tube for performing a “real-ear measurement”.

18. A kit comprising an adapter according to claim 4 and a probe tube for performing a “real-ear measurement”.

19. A kit comprising an adapter according to claim 5 and a probe tube for performing a “real-ear measurement”.

20. A kit comprising an adapter according to claim 6 and a probe tube for performing a “real-ear measurement”.
